(19) United States
(12) Patent Application Publication
(10) Pub. No.: US 2009/0292842 A1
(43) Pub. Date: Nov. 26, 2009

(54) Data access device with wireless network application service

(75) Inventor: NICHOLAS DAVID FOTHERGILL-ZITTRER, Toronto (CA)

Correspondence Address: Wang Law Firm, Inc., 4989 Peachtree Parkway,, Suite 200, Norcross, GA, 30092, US

(73) Assignee: Huveur Technologies Inc., Taichung City (TW)

(21) Appl. No.: 12/465,720

(22) Filed: May 14, 2009

(30) Foreign Application Priority Data
May 21, 2008 (TW) 097208867

(51) Int. Cl. G06F 13/42; H04W 84/02

(52) U.S. Cl. 710/106; 370/338

(57) ABSTRACT

A data access device with a wireless network application service includes a microprocessing unit, a wireless network module, and a memory unit, and the data access device is connected to a main system through a USB interface. The memory unit includes two memory blocks, and the first memory block is provided for the device to access data and includes a wireless network module driver program and a network service software for connecting a network service, and the second memory block is provided for the main system to access data and the data downloaded from a network service by the network service software.

### BACKGROUND OF THE INVENTION

1. Field of the Invention

The present invention generally relates to a data access device, and more particularly to a data access device with a wireless network application service.

2. Description of the Related Art

In a conventional multimedia display device such as a digital photo frame, the multimedia display device reads, loads and displays a multimedia picture stored by the data access device after a data access device is installed, but the conventional multimedia display device cannot be connected to a multimedia website through a wireless network to access multimedia pictures.

In a conventional multimedia display device such as an external wireless network connecting device, it is necessary to install and execute a wireless network driver program for connecting the device. However, not all multimedia display devices have installed a driver program, and different wireless network connecting devices must execute different driver programs. Obviously, such application causes tremendous troubles and occupies lots of memory spaces of the multimedia display device, and the prior art requires further improvements.

### SUMMARY OF THE INVENTION

Therefore, it is a primary objective of the present invention to provide a data access device with a wireless network application service, and the data access device comprises a wireless network module, a memory unit, and a microprocessing unit, such that after the data access device is connected with the multimedia display device, a picture of a specific website can be downloaded through a network to the multimedia display device and displayed by the multimedia display device.

To achieve the foregoing objective, the present invention provides a data access device comprising: a microprocessing unit; a USB input/output module, electrically coupled to the microprocessing unit, and having a transmission interface of a USB port connected to the main system; a wireless network module, electrically coupled to the microprocessing unit, for receiving and transmitting an electric signal to a connected network; a memory unit, electrically coupled to the microprocessing unit, and having a first storage block and a second storage block, and the first storage block being provided only for the microprocessing unit to access data and having a driver program for driving the wireless network module, and a network service software connected to a network service through the wireless network module, and the second storage block being provided only for the main system to access data through the USB input/output module and store a data downloaded from the network service by the network service software.

### BRIEF DESCRIPTION OF THE DRAWINGS

FIG. 1 is a schematic view of a data access device connected to a multimedia display device in accordance with the present invention;

FIG. 2 is a schematic view of a data access device in accordance with the present invention;

FIG. 3 is a schematic view of a data access device using a wireless network module to access a multimedia picture in accordance with the present invention; and

FIG. 4 is a schematic view of a data access device connected to a SIM card in accordance with the present invention.

### DETAILED DESCRIPTION OF THE PREFERRED EMBODIMENTS

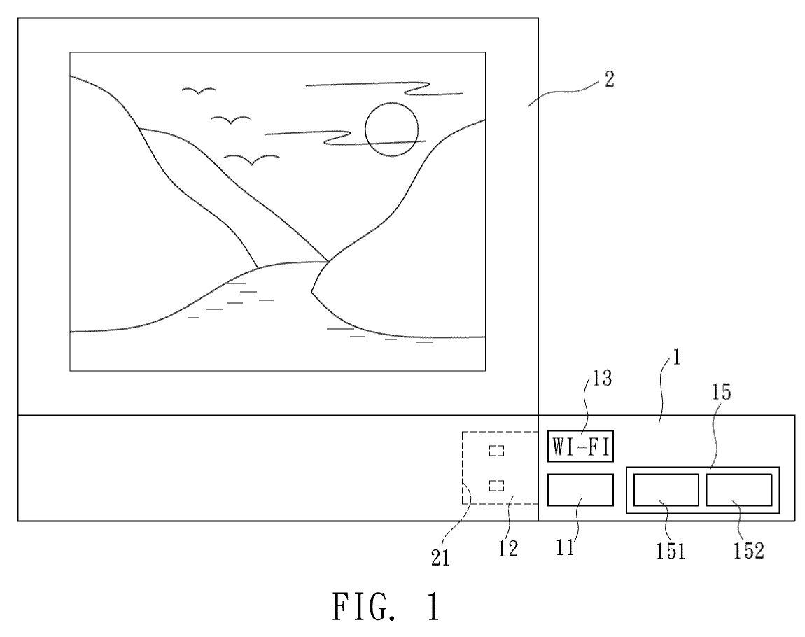

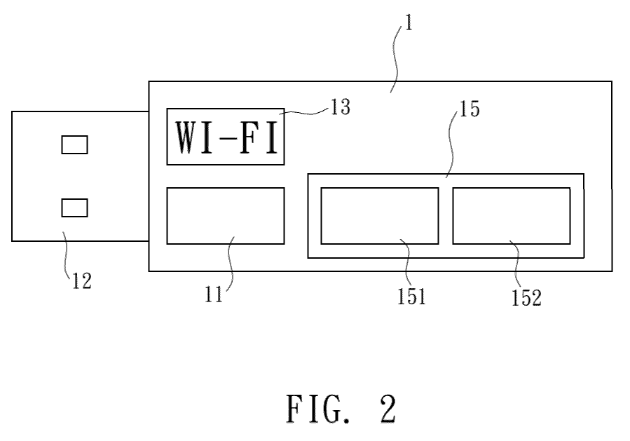

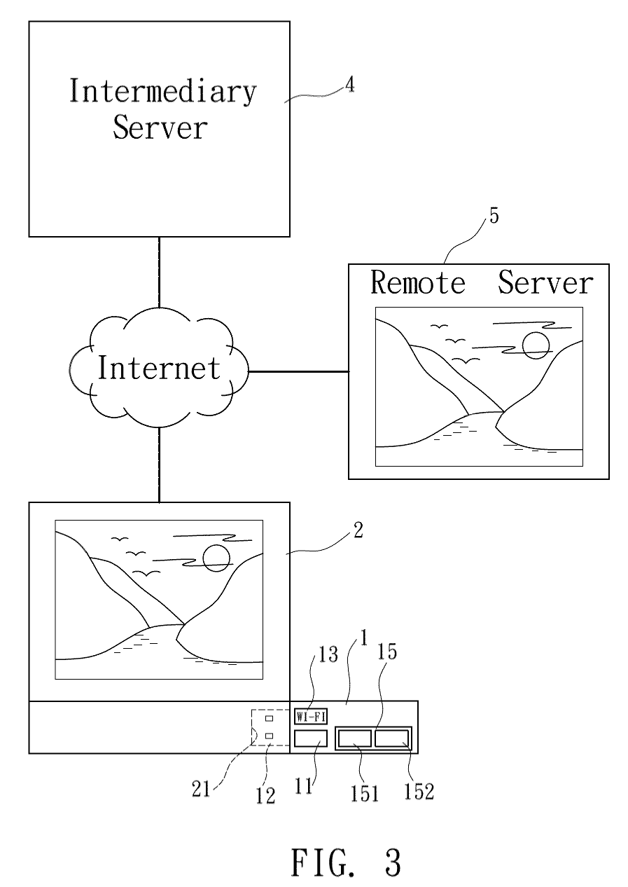

With reference to FIGS. 1 to 4 for a preferred embodiment of the present invention, the preferred embodiment is provided for illustrating the invention only, but not intended for limiting the scope of the invention.

In the preferred embodiment of the present invention, a data access device with a wireless network application service 1 is connected to a main system 2 and provided for the main system 2 to access data, and the data access device comprises:

a microprocessing unit 11;

a USB input/output module 12, electrically coupled to the microprocessing unit 11, and having a transmission interface 21 of a USB port connected to the main system 2, wherein the USB input/output module 12 of the preferred embodiment complies with an interface specification of a USB standard, a Mini USB standard or a USB On-The-Go Supplement standard, and the main system 2 connected to the USB input/output module 12 is a personal digital assistant (PDA), a mobile phone, a digital photo frame, a digital camera, a portable multimedia player, a palm game player, a computer, a notebook computer, a flat panel computer or any device with a USB interface;

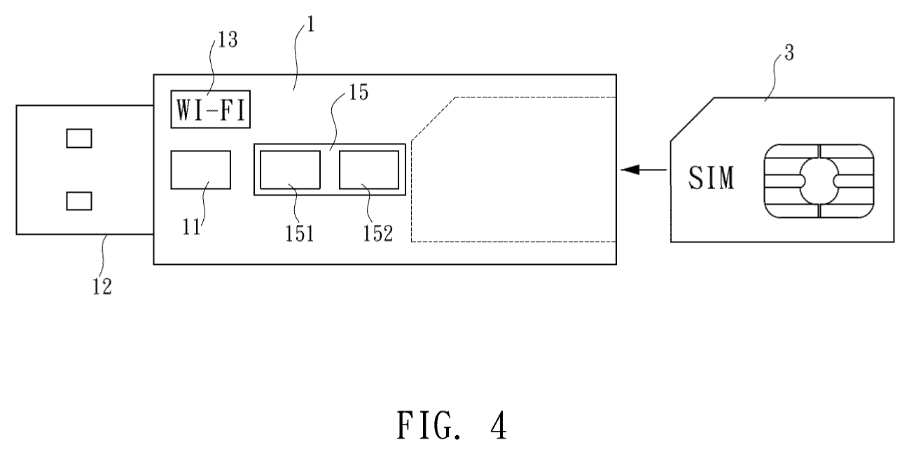

a wireless network module 13, electrically coupled to the microprocessing unit 11, for receiving and transmitting an electric signal of a connected network, wherein the wireless network module 13 of the preferred embodiment is a network module of a Wi-Fi standard, an IEEE 802.11 standard, an IEEE 802.11a standard, an IEEE 802.11b standard, an IEEE 802.11g standard, an IEEE 802.11i standard or an IEEE 802.11n standard, and the wireless network module 13 is a network module compatible to a worldwide interoperability for microwave access (WiMAX) standard, an IEEE 802.16d standard or an IEEE 802.16e standard; and the wireless network module 13 further includes a mobile network unit, and a connecting interface 14 for electrically connecting a SIM card 3 of a mobile phone service (as shown in FIG. 4), and the mobile network unit is provided for receiving and transmitting an electric signal; of a wireless mobile network and connected to a network, and the first storage block further includes a diver program for driving the mobile network unit, and the SIM card 3 complies a transmission technology standard of a general packet radio service (GPRS), a 3rd-generation (3G) communication, a high speed downlink packet access (HSDPA), a high speed uplink packet access (HSUPA) a 4th-generation (4G) communication; a memory unit 15, electrically coupled to the microprocessing unit 11, and having a first storage block 151 and a second storage block 152, wherein the first storage block 151 is provided only for the microprocessing unit 11 to access data and includes a driver program for driving the wireless network module 13, and uses the wireless network module 13 to connect a network service software of a network service, and the second storage block 152 is provided only for the main system 2 to access data through the USB input/output module 12, and store data downloaded from the network service by the network service software.

In this preferred embodiment, the network service software is provided for connecting and transmitting an identification code to an intermediary server 4, and the intermediary server 4 includes a user database for storing user related data and corresponding data of the connected remote server 5. After the intermediately server 4 reads and approves the identification code, the network service software connects a default remote server 5 according to the stored content of the user database, and stores the corresponding multimedia data of the remote server 5 back into the second storage block 152.

From the description above, the data access device 1 not only provides a function of storing data only, but also adds a wireless network module 13 for connecting a network service and transmitting data, as well as downloading a specified picture of a multimedia website to a specified multimedia display device 2, so that a conventional data storage device 1 such as a USB input/output module 12 can have the wireless networking function.

What is claimed is:

1. A data access device with a wireless network application service, connected to a main system and provided for the main system to access data, and the data access device comprising:
a microprocessing unit;
a USB input/output module, electrically coupled to the microprocessing unit, and having a transmission interface of a USB port connected to the main system;
a wireless network module, electrically coupled to the microprocessing unit, for receiving and transmitting an electric signal to a connected network;
a memory unit, electrically coupled to the microprocessing unit, and having a first storage block and a second storage block, and the first storage block being provided only for the microprocessing unit to access data and having a driver program for driving the wireless network module, and a network service software connected to a network service through the wireless network module, and the second storage block being provided only for the main system to access data through the USB input/output module and store a data downloaded from the network service by the network service software.

2. The data access device with a wireless network application service as recited in claim 1, wherein the input/output module complies with an interface specification of a USB standard, a Mini USB standard, a USB On-The-Go Supplement standard.

3. The data access device with a wireless network application service as recited in claim 1, wherein the main system connected to the input/output module is a personal digital assistant (PDA), a mobile phone, a digital photo frame, a digital camera, a portable multimedia player, a palm game player, a computer, a notebook computer, a flat panel computer or any device with a USB interface.

4. The data access device with a wireless network application service as recited in claim 1, wherein the wireless network module is a network module of a Wi-Fi standard, an IEEE 802.11 standard, an IEEE 802.11a standard, an IEEE 802.11b standard, an IEEE 802.11g standard, an IEEE 802.11i standard or an IEEE 802.11n standard.

5. The data access device with a wireless network application service as recited in claim 1, wherein the wireless network module is a network module compatible to a Worldwide Interoperability for Microwave Access (WiMAX) standard, an IEEE 802.16d standard or an IEEE 802.16e standard.

6. The data access device with a wireless network application service as recited in claim 1, wherein the wireless network module further includes a mobile network unit and a connecting interface provided for electrically connecting a SIM card of the mobile phone service, and the mobile network unit is provided for transmitting and receiving an electric signal to a wireless mobile network, and connected to a network, and the first storage block further includes a driver program for driving the mobile network unit.

7. The data access device with a wireless network application service as recited in claim 6, wherein the SIM card complies with a transmission technology standard of a general packet radio service (GPRS), a 3rd-generation (3G) mobile communication, a high speed downlink packet access (HSDPA), a high speed uplink packet access, (HSUPA) or a 4th-generation (4G) mobile communication.

8. The data access device with a wireless network application service as recited in claim 1, wherein the network service software is provided for connecting an intermediately server and transmitting an identification code, and the intermediary server includes a user database for storing a user related data and a corresponding data of the connected remote server, and after the intermediary server reads and approves the identification code, the network service software connects a default remote server according to a corresponding data of the user database of a connected remote server, and stores a corresponding multimedia data of the remote server back into the second storage block.
